(19) United States
(12) Patent Application Publication
(10) Pub. No.: US 2003/0213927 A1
(43) Pub. Date: Nov. 20, 2003

(54) Modular fuel control valve

(76) Inventor: Geoffrey V. Hemsley, Kent, WA (US)

Correspondence Address: EDWARD A SOKOLSKI, 3868 CARSON STREET, 105, TORRANCE, CA, 90503, US

(21) Appl. No.: 10/150,364

(22) Filed: May 17, 2002

(51) Int. Cl. F16K 31/02

(52) U.S. Cl. 251/129.15

(57) ABSTRACT

A control valve for controlling the supply of natural gas fuel to a device utilizing such fuel operates to regulate the fuel supply in response to an actuator employing a solenoid which is responsive to electrical control signals. The flow of fuel from the fuel supply to the utilizing device passes through a valve formed by a piston and a valve seat. The valve is normally held in its closed position with the piston in abutment against the valve seat by a spring. When the solenoid is actuated by electrical control signals it drives a drive shaft in the actuator which in turn drives the piston away from the valve seat against the spring action, thereby opening the valve to permit fuel to pass through to the utilizing device. The applied control current is converted to force in near linear fashion to drive the valve adjustably between its closed and fully open position. A plug is provided in the housing for the fuel valve to permit ready access to the components of the valve assembly which are made in individual modules so that they can be readily removed for cleaning, repair or replacement.

### BACKGROUND OF THE INVENTION

1. Field of the Invention

This invention relates to a natural gas fuel supply for a device utilizing natural gas such as an internal combustion engine, gaseous fueled fuel cells, or other device employing pressurized process gas, and more particularly to a control valve for controlling the feeding of natural gaseous fuel in response to a solenoid actuator driven by electrical control signals.

2. Description of the Related Art

Natural gas fuel used in internal combustion engines or as fuel for other devices has substantial environmental benefits over gasoline or other liquid fuels in that the exhaust emissions of an engine using such fuel are extremely low. Systems have been developed in the prior art which employ solenoid actuators driven by electrical control signals which are in accordance with the desired fuel flow. The solenoid actuators drive a control valve through which the gas fuel is fed from the fuel supply source to the vehicle engine. Such a system is described in U.S. Pat. No. 6,224,033 issued May 1, 2001 to Kumar and U.S. Pat. No. 6,047,947 issued Apr. 11, 2000 to Kumar. One of the shortcomings of prior art systems is overly complicated construction which leads to high costs. Further, the construction is such that disassembly for replacement and cleaning of parts is difficult or impossible. Further in the event of a failure due to excessive over pressure at the inlet, the valves of prior art systems will not open even with maximum control current applied. This renders the vehicle unstartable and can cause damage to the valve. Valves of the prior art have exhibited calibration differences between different new models and drift in calibration with use.

### SUMMARY OF THE INVENTION

The present invention provides an improvement over the prior art by providing a gas fuel control valve module which is considerably simpler and less costly to manufacture than prior art valves and which has a modular design which permits ready repair, cleaning and replacement of components. Further, in view of its simple design and sturdy components, the system of the present invention has increased capacity to hold its calibration with use. In addition, the system of the present invention has a fail safe design which tends to obviate failures due to over pressure at the inlet.

The system of the present invention employs a control valve which operates to control the gas fuel supply to a utilization device such as an engine in response to a solenoid actuator responsive to electrical control signals. The flow of fuel from the fuel supply to the utilization device passes through a valve formed by a piston having a plastic seal and a valve seat against which the piston abuts. The valve is normally held in a closed position with the piston tightly held against the valve seat by means of a spring which abuts against the piston. When the solenoid is actuated by an electrical control signal generated in response to control by the controller of the device, it drives a control shaft which in turn drives the piston away from the valve seat against the spring action, thereby opening the valve to permit fuel to pass to the engine.

It is therefore an object of this invention to provide an improved fuel control valve assembly for controlling the natural gas fuel supply to a vehicle engine.

It is a further object of this invention to provide a fuel control valve assembly which is modular in construction.

It is still a further object of this invention to provide a fuel control valve assembly which is simpler and more economical in construction than prior art such devices.

Other objects of the invention will become apparent from the following description taken in connection with the accompanying drawings.

### DESCRIPTION OF THE DRAWINGS

FIG. 1 is a perspective schematic view illustrating the system of invention along with a solenoid actuator;

FIG. 2 is a cross sectional view showing a preferred embodiment of the invention with its valve in an open position;

FIG. 3 is a cross sectional view of the preferred embodiment showing the valve in a closed position;

FIG. 4 is an exploded view showing the plug removed from the housing along with elements of the preferred embodiment; and

FIG. 5 is a schematic drawing of the system of the invention.

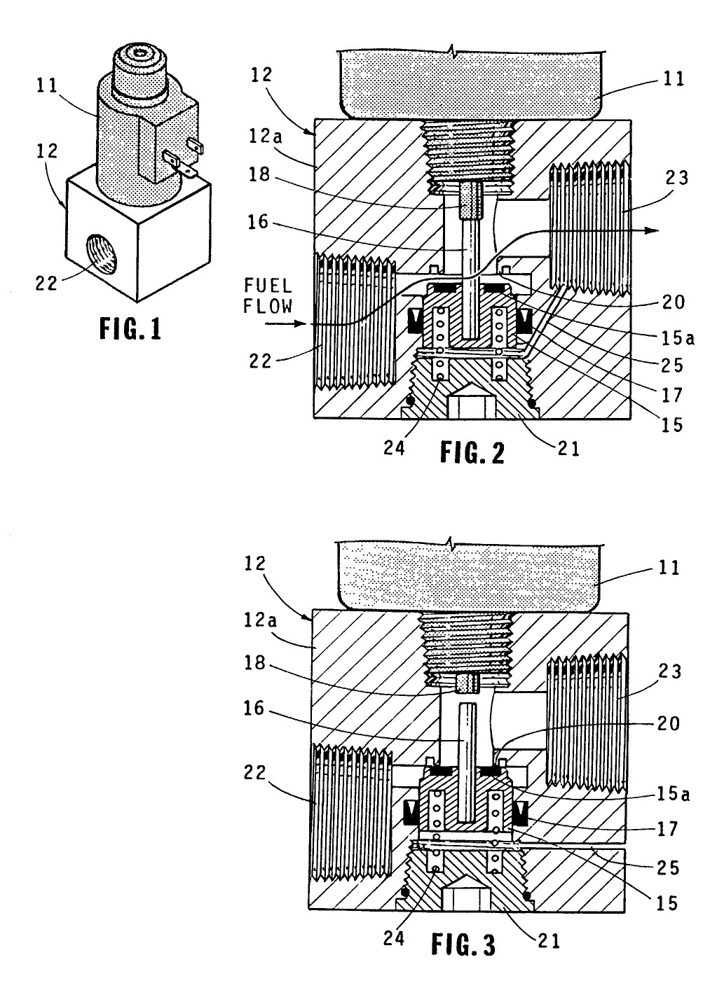

### DETAILED DESCRIPTION OF THE INVENTION

Referring now to the Figures, a preferred embodiment of the invention is illustrated.

Solenoid actuator 11 provides mechanical control signals for modular fuel control valve 12 which open the valve in response to electrical signals fed to the actuator. These electrical signals are generated in response to the control of the fuel supply by the operator of the vehicle or other device being controlled. The solenoid actuator is preferably one having low hysteresis which provides accurate response to the electrical control signals fed thereto. Solenoid actuator part number CH-09813-002 and associated parts manufactured by Magnet-Schultz of America, Inc., 401 Plaza Drive, Westmont, Ill.60559 may be employed.

The output shaft 18 of the solenoid actuator abuts against dowel pin 16 of the modular flow control valve 12. Dowel pin 16 is press fitted into piston 15. Piston 15 is cylindrical and has a seal 15a installed on its upper surface. A valve seat is formed between the lower surface of seat member 20 and the upper surface of the piston. The valve is normally held in its closed position with the seal 15a of the piston in tight abutment against the surface of the valve seat member by means of spring 24; one end of which abuts against the piston and the other end of which abuts against an indentation formed in removable threaded plug member 21. Seal member 17 is installed around piston 15 to seal the upstream and downstream pressures which are on either side of the piston during operation. This seal member is of a low friction material such as Carboxilated Nitrile available from Parker Hannifin Corporation, Salt Lake City, Utah. To assure low resistance to the axial motion of the piston, the surface of the piston is plated with a smooth wear resistant nickel plating and the surface of the bore in which the piston is fitted has a smooth hard anodized aluminum surface.

The valve is shown in its open position in FIG. 2 with the solenoid being actuated to drive pin 16 downwardly against the resistive action of spring 24. This enables gas flow between gas inlet 22 and gas outlet 23 as indicated by arrow “A.” The device can also be configured for flow in the reverse direction depending on pressure flow and packaging requirements. The valve is shown in its closed position in FIG. 3 with the flow of gas being shut off by the valve in response to the action of spring 24.

As can be seen in FIGS. 2 and 3 the cavity below piston 15 is exposed to a fixed or controlled downstream pressure by the interconnection 25 between the cavity and the gas outlet 23. In the alternative, the interconnection 25 can run directly to the ambient atmosphere as shown in FIG. 3.

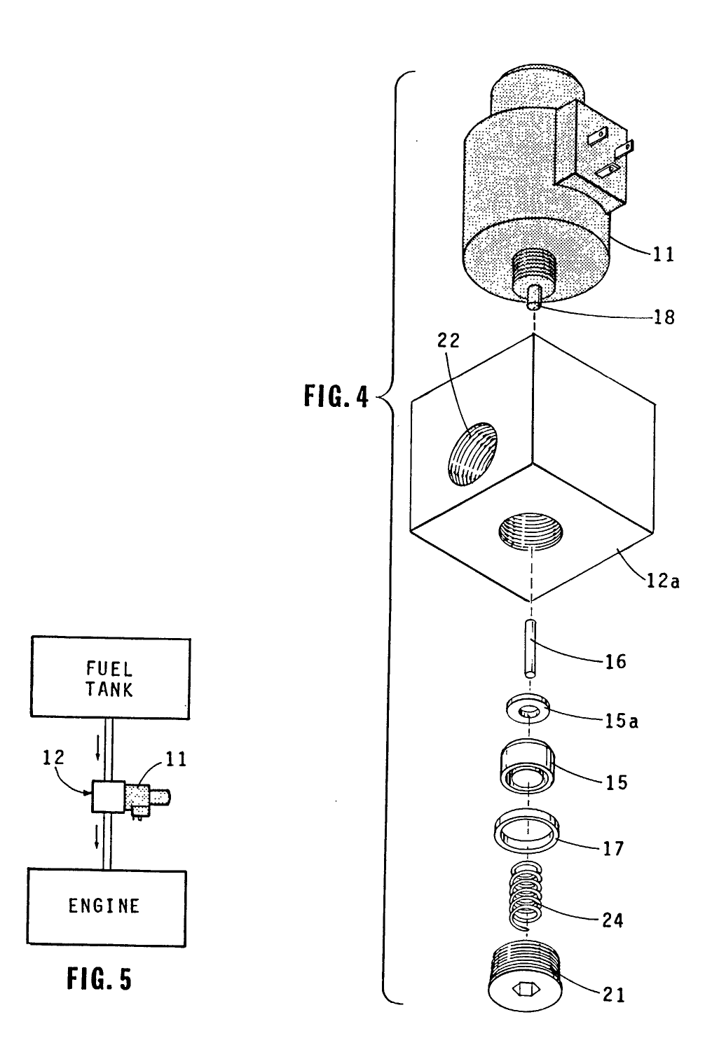

As shown in FIG. 4, The components of the modular control valve can readily be removed from the housing 12a in which they are contained for replacement or repair by removing plug 21. As the components are separable, they can be individually removed.

As shown in FIG. 5, The gas from the tank flows through the valve(when it is open) to the engine.

While the invention has been described and illustrated in detail it is to be understand that this is intended by way of illustration and example only, the scope of the invention being limited by the terms of the following claims.

I claim:

1. In combination, a solenoid actuator having a drive shaft driven in response to electrical control signals fed to said solenoid actuator and a modular control valve driven by the drive shaft of said solenoid assembly adjustably between closed and open positions to selectively provide gaseous fuel to a device utilizing said fuel, said modular control valve comprising:
a housing;
a piston member slidably mounted in said housing;
a pin member attached to said piston member at one end thereof and abutting against the drive shaft of said solenoid actuator at the other end thereof;
a seat member mounted in said housing forming a valve seat with said piston member,
Spring means for resiliently driving said piston member into abutment with said seat member in the absence of an electrical control signal being fed to said solenoid actuator, thereby closing said valve, the drive shaft of said solenoid actuator opening said valve when an electrical control signal is present, and
a plug member removably attached to said housing;
whereby when said plug member is removed from said housing, said piston member, said pin member and said spring means are slidably removable from the housing.

2. The device of claim 1 wherein the spring means comprises a coil spring.

3. The device of claim 1 and further including a seal member mounted on said piston member forming a seal between said piston member and the valve seat.

4. The device of claim 1 wherein the plug member is threadably attached to said housing.

5. The device of claim 1 wherein the outer wall of said piston is in abutment with the inner wall of said housing, and further including a low resistance material between the outer wall of said piston and the inner wall of said housing.

6. The device of claim 5 wherein the inner wall of the housing is circular and the outer wall of the piston is cylindrical.

7. The device of claim 1 wherein the pin member is press fitted into said piston assembly.
